(19) United States
(12) Patent Application Publication
(10) Pub. No.: US 2018/0218262 A1
(43) Pub. Date: Aug. 2, 2018

(54) CONTROL DEVICE AND CONTROL METHOD

(71) Applicant: Panasonic Intellectual Property Corporation of America, Torrance, CA (US)

(72) Inventor: MASASHI OKADA, Osaka (JP)

(21) Appl. No.: 15/877,288

(22) Filed: Jan. 22, 2018

Related U.S. Application Data
(60) Provisional application No. 62/452,614, filed on Jan. 31, 2017.

(30) Foreign Application Priority Data
Oct. 26, 2017 (JP) 2017-207450

(51) Int. Cl. G06N 3/08; G05B 13/02

(52) U.S. Cl. CPC G06N 3/084; G05B 13/0285

(57) ABSTRACT

A control device for performing optimal control by path integral includes a neural network section including a machine-learned dynamics model and cost function, an input section that inputs a current state of a control target and an initial control sequence for the control target into the neural network section, and an output section that outputs a control sequence for controlling the control target, the control sequence being calculated by the neural network section by path integral from the current state and the initial control sequence by using the dynamics model and the cost function. Here, the neural network section includes a second recurrent neural network incorporating a first recurrent neural network including the dynamics model.

### BACKGROUND

### 1. Technical Field

The present disclosure relates to control devices and control methods and in particular to a control device and control method using a neural network.

### 2. Description of the Related Art

One known exemplary optimal control is path integral control (see, for example, Model Predictive Path Integral Control: From Theory to Parallel Computation retrieved Sep. 29, 2017, from https://arc.aiaa.org/doi/full/10.2514/1.G001921 (hereinafter referred to as Non Patent Literature 1)). The optimal control can be considered as a scheme for predicting a future state and reward of a control target system and determining an optimal control sequence. The optimal control can be formularized as an optimization problem with constraints.

A deep neural network, such as a convolutional neural network, has been well applied and used in controlling for, for example, automatic driving or robot operation.

### SUMMARY

Traditional optimal control such as the one in Non Patent Literature 1 needs to identify the dynamics of the system and use a cost function to predict the future state and future reward of the system. Unfortunately, however, it is difficult to describe the dynamics and cost function.

There is also the problem that the optimal control cannot be achieved by using a deep neural network, such as a convolutional neural network. This is because no matter how much it learns, the deep neural network, such as the convolutional neural network, develops only reactively.

One non-limiting and exemplary embodiment provides a control device and control method capable of performing optimal control using a neural network.

In one general aspect, the techniques disclosed here feature a control device for performing optimal control by path integral. The control device includes a processor and a non-transitory memory storing thereon a computer program, which when executed by the processor, causes the processor to perform operations. The operations include inputting a current state of a control target and an initial control sequence being a control sequence having a plurality of control parameters for the control target as its components into a neural network including a machine-learned dynamics model and cost function, and outputting a control sequence for controlling the control target, the control sequence being calculated by the neural network by path integral from the current state and the initial control sequence by using the dynamics model and the cost function. The neural network includes a second recurrent neural network incorporating a first recurrent neural network including the dynamics model.

According to the control device and the like in the present disclosure, optimal control using a neural network can be performed.

It should be noted that general or specific embodiments may be implemented as a system, a method, an integrated circuit, a computer program, a computer-readable storage medium, such as a compact disk read-only memory (CD-ROM), or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram that illustrates one example of a configuration of a control device according to an embodiment;

FIG. 2 is a block diagram that illustrates one example of a configuration of a neural network section illustrated in FIG. 1;

FIG. 3A is a block diagram that illustrates one example of a configuration of a calculating section illustrated in FIG. 2;

FIG. 3B illustrates one example of a detailed configuration of the calculating section illustrated in FIG. 2;

FIG. 4 illustrates one example of a detailed configuration of a Monte Carlo simulator illustrated in FIG. 3B;

FIG. 5 illustrates one example of a detailed configuration of a second processor illustrated in FIG. 3B;

FIG. 6 is a flow chart that illustrates processing in the control device according to the embodiment;

FIG. 7 illustrates one example of a conceptual diagram of learning processing according to the embodiment;

FIG. 8 is a flow chart that illustrates an outline of the learning processing according to the embodiment;

FIG. 9 illustrates results of control simulation in an experiment;

FIG. 10A illustrates a real cost function;

FIG. 10B illustrates a learned cost function in a path integral control neural network;

FIG. 10C illustrates a learned cost function in a neural network in a comparative example; and

FIG. 11 is a block diagram that illustrates one example of a configuration of a neural network section according to a first variation.

### DETAILED DESCRIPTION

### (Underlying Knowledge Forming Basis of the Present Disclosure)

Optimal control, which is control minimizing an evaluation function indicating the control quality is known. The optimal control can be considered as a scheme for predicting a future state and reward of a control target system and determining an optimal control sequence. The optimal control can be formularized as an optimization problem with constraints.

One known exemplary optimal control is path integral control (see, for example, Non-Patent Document 1). Non Patent document 1 describes performing path integral control by mathematically solving path integral as a stochastic optimal control problem by using Monte Carlo approximation based on the stochastic sampling of trajectories.

Traditional optimal control such as the one in Non Patent Literature 1 needs to use the dynamics identifying the system and the cost function to predict the future state and future reward of the system. Unfortunately, however, it is difficult to describe the dynamics and cost function. If the model of the system is fully known, the dynamics including complex equations and many parameters can be described, but this is a rare case. In particular, describing many parameters is difficult. Similarly, the cost function for use in evaluating the reward can be described if changes in all situations of an environment between a current state and a future state of the system are fully known or can be fully simulated, but this case is not common. The cost function is described as a function indicating what state is desired by using a parameter, such as a weight, to achieve desired control. The parameter, such as the weight, is particularly difficult to optimally describe.

As previously described, in recent years, a deep neural network, such as a convolutional neural network, has been well applied and used in controlling for, for example, automatic driving or robot operation. Such a deep neural network is trained to output desired control by imitation learning based on training data or reinforcement learning.

One approach to achieving optimal control may be the use of a deep neural network, such as a convolutional neural network. If the optimal control can be achieved by using such a deep neural network, a dynamics and cost function required for the optimal control or their parameters, which are particularly difficult to describe, can learn.

Unfortunately, however, the optimal control cannot be achieved by using the deep neural network, such as the convolutional neural network. This is because such a deep neural network develops only reactively, no matter how much it learns. That is, it is impossible for the deep neural network to obtain generalization capability, such as prediction, no matter how much it learns.

In light of the above circumstances, the inventor conceives a control device and control method capable of achieving optimal control using a neural network.

A control device according to one aspect of the present disclosure is a control device for performing optimal control by path integral. The control device includes a processor and a non-transitory memory storing thereon a computer program, which when executed by the processor, causes the processor to perform operations. The operations include inputting a current state of a control target and an initial control sequence being a control sequence having a plurality of control parameters for the control target as its components into a neural network including a machine-learned dynamics model and cost function, and outputting a control sequence for controlling the control target, the control sequence being calculated by the neural network by path integral from the current state and the initial control sequence by using the dynamics model and the cost function. The neural network includes a second recurrent neural network incorporating a first recurrent neural network including the dynamics model.

With this configuration, because the neural network including the double recurrent neural network can perform optimal control by path integral, the optimal control using the neural network can be achieved.

Here, for example, the second recurrent neural network may include a first processor that includes the first recurrent neural network and the cost function and that causes the first recurrent neural network to calculate states at times by a Monte Carlo method from the current state and the initial control sequence and to calculate costs of the plurality of states by using the cost function, and a second processor that calculates the control sequence for the control target on the basis of the initial control sequence and the costs of the plurality of states. The second processor may output the calculated control sequence and feed the calculated control sequence as the initial control sequence back to the second recurrent neural network. The second recurrent neural network may cause the first processor to calculate costs of a plurality of states at times subsequent to the times from the control sequence fed back from the second processor and the current state.

With this configuration, the neural network including the double neural network can perform the optimal control by path integral by the Monte Carlo method.

Furthermore, for example, the second recurrent neural network may further include a third processor that generates random numbers by the Monte Carlo method, and the third processor may output the generated random numbers to the first processor and the second processor.

For example, the control target may be a vehicle capable of autonomously driving or a robot capable of autonomously moving, the cost function may be a cost function model included in the neural network, and in the outputting, the control sequence may be output to the vehicle or the robot, and the vehicle or the robot may be controlled.

A control method according to another aspect of the present disclosure is a control method for use in a control device for performing optimal control by path integral. The control method includes inputting a current state of a control target and an initial control sequence being a control sequence having a plurality of control parameters for the control target as its components into a neural network including a machine-learned dynamics model and cost function, and outputting a control sequence for controlling the control target, the control sequence being calculated by the neural network by path integral from the current state and the initial control sequence by using the dynamics model and the cost function. The neural network includes a second recurrent neural network incorporating a first recurrent neural network including the dynamics model.

Here, for example, the control method may further include learning before the inputting, in the learning, the dynamics model and the cost function are subjected to machine learning. The leaning may include preparing learning data as training data, the learning data including a prepared state corresponding to the current state of the control target, a prepared initial control sequence corresponding to the initial control sequence for the control target, and a control sequence for controlling the control target calculated by path integral from the prepared state and the prepared initial control sequence, and causing the dynamics model and the cost function to learn by causing a weight in the neural network to learn by backpropagation by using the training data.

Thus, the dynamics and cost function required for the optimal control or their parameters in the neural network including the double recurrent neural network can learn.

Here, for example, the control target may be a vehicle capable of autonomously driving or a robot capable of autonomously moving, the cost function may be a cost function model included in the neural network, and in the outputting, the control sequence may be output to the vehicle or the robot, and the vehicle or the robot may be controlled.

The embodiments described below indicates one specific example of the present disclosure. The numerical values, shapes, constituent elements, steps, order of steps, and the like are examples and are not intended to restrict the present disclosure. Constituent elements described in the embodiments below but not stated in the independent claims representing the broadest concept of the present disclosure are described as optional constituent elements. The contents in all the embodiments may be combined.

### Embodiments

A control device, control method, and the like according to an embodiment are described below with reference to the drawings.

### [Configuration of Control Device 1]

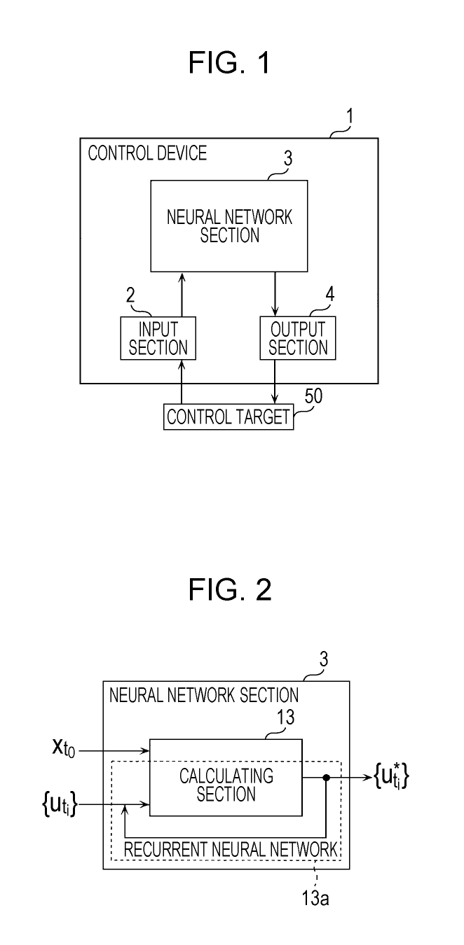

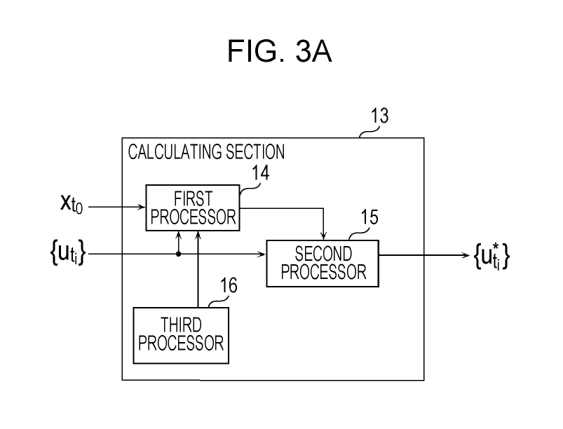

FIG. 1 is a block diagram that illustrates one example of a configuration of a control device 1 according to the present embodiment. FIG. 2 is a block diagram that illustrates one example of a configuration of a neural network section 3 illustrated in FIG. 1.

The control device 1 is implemented as a computer using a neural network or the like and performs optimal control by path integral on a control target 50. One example of the control device 1 includes an input section 2, the neural network section 3, and an output section 4, as illustrated in FIG. 1. Here, the control target 50 is a control target system to be subjected to optimal control, and examples thereof may include a vehicle capable of autonomously driving and a robot capable of autonomously moving.

### <Input Section 2>

The input section 2 inputs a current state of the control target and an initial control sequence being a control sequence having a plurality of control parameters for the control target as its components into the neural network in the present disclosure.

In the present embodiment, the input section 2 obtains a current state of the control target 50

xₜ_{₀}

and an initial control sequence having initial control parameters for the control target 50

{uₜ_{ᵢ}}

from the control target 50 and inputs them into the neural network section 3. Here,

{uₜ_{ᵢ}}

indicates a time series of control from times t_0 to L{N−1}.

### <Output Section 4>

The output section 4 outputs a control sequence for controlling the control target calculated by the neural network section 3 by path integral from the current state and the initial control sequence by using a machine-learned dynamics model and cost function. Examples of the dynamics model may include a dynamics model included in a neural network and a function expressed as a numerical formula. Similarly, examples of the cost function may include a cost function model included in a neural network and a function expressed as a numerical formula. That is, the dynamics and cost function may be included in a neural network or may be a function including a numerical formula and a parameter as long as they can be machine-learned in advance.

In the present embodiment, the initial control sequence

{uₜ_{ᵢ}}

obtained by the input section 2 from the control target 50 is updated to the control sequence

{uₜ_{ᵢ}*},

and this updated control sequence is output from the output section 4 to the control target 50. That is, on the basis of the initial control sequence

{uₜ_{ᵢ}},

the control device 1 outputs the control sequence

{uₜ_{ᵢ}*},

which is the optimal control sequence calculated by predicting a future state and reward of the control target 50, to the control target 50.

### <Neural Network Section 3>

The neural network section 3 includes a neural network including a machine-learned dynamics model and cost function. The neural network section 3 includes a second recurrent neural network incorporating a first recurrent neural network including the machine-learned dynamics model. Hereinafter, the neural network section 3 is sometimes referred to as a path integral control neural network.

The neural network section 3 calculates a control sequence for controlling the control target by path integral from the current state and the initial control sequence by using the machine-learned dynamics model and cost function.

In the present embodiment, as illustrated in FIG. 2, the neural network section 3 includes a calculating section 13. The calculating section 13 receives the current state of the control target 50

xₜ_{₀}

and the initial control sequence for the control target 50

{uₜ_{ᵢ}}

from the input section 2. The calculating section 13 calculates a control sequence in which the initial control sequence

{uₜ_{ᵢ}}

is updated by path integral by using the machine-learned dynamics model and cost function. The calculating section 13 receives the updated control sequence again as the initial control sequence

{uₜ_{ᵢ}}

and calculates the control sequence in which the updated control sequence is further updated. In this way, the calculating section 13 recurrently updates the control sequence, for example, U times and thus calculates the control sequence for controlling the control target 50

{uₜ_{ᵢ}*}

The portion that recurrently updates the control sequence in the calculating section 13 corresponds to a recurrent neural network 13a. One example of the recurrent neural network 13a may be the second recurrent neural network.

The U times are set at a large number at which the updated control sequence can sufficiently converge. The dynamics model is expressed as a function f parameterized by machine learning. The cost function model is expressed as a function

\hat{q}

and ϕ parameterized by machine learning.

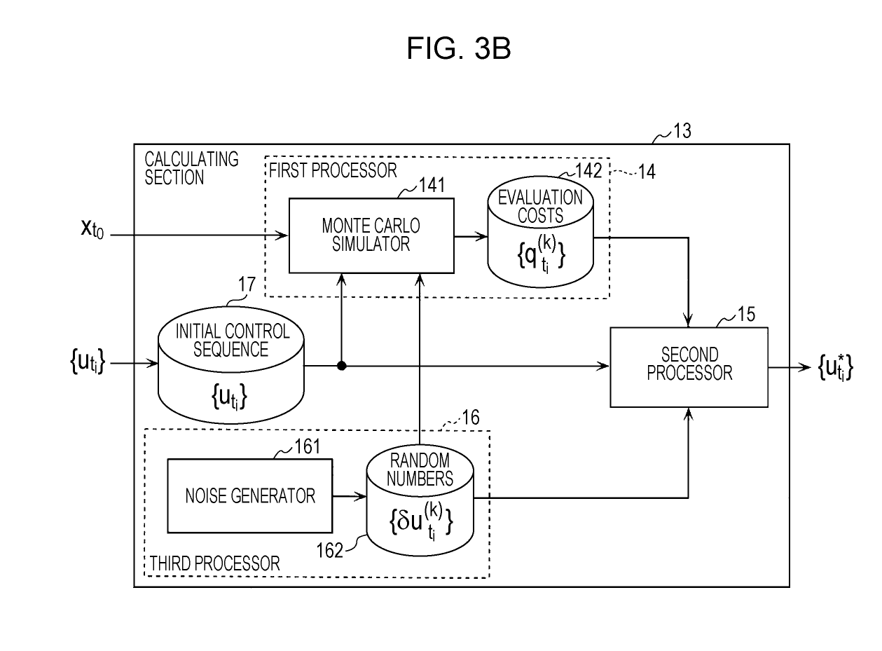

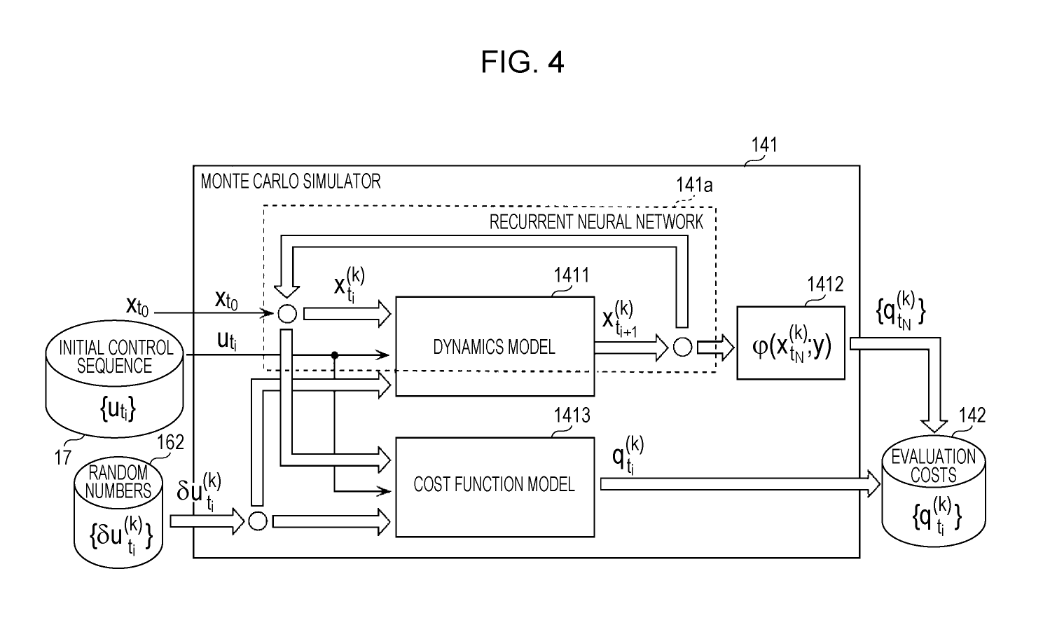

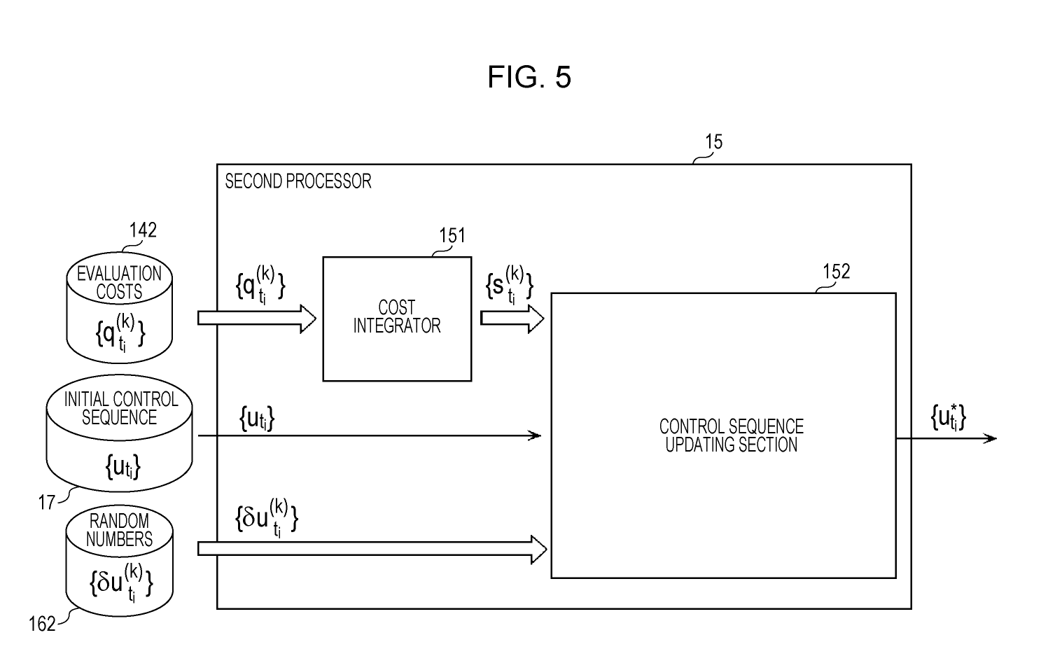

FIG. 3A is a block diagram that illustrates one example of a configuration of the calculating section 13 illustrated in FIG. 2. FIG. 3B illustrates one example of a detailed configuration of the calculating section 13 illustrated in FIG. 2. FIG. 4 illustrates one example of a detailed configuration of a Monte Carlo simulator 141 illustrated in FIG. 3B. FIG. 5 illustrates one example of a detailed configuration of a second processor 15 illustrated in FIG. 3B.

The calculating section 13 includes a first processor 14, the second processor 15, and a third processor 16, as illustrated in, for example, FIG. 3A. The calculating section 13 may further include a storage 17 for storing an initial control sequence input from the input section, as illustrated in, for example, FIG. 3B, and the storage 17 may output it to the first processor 14 and second processor 15.

### <<First Processor 14>>

The first processor 14 includes the first recurrent neural network and the cost function and causes the first recurrent neural network to calculate states at times by the Monte Carlo method from the current state and the initial control sequence and calculates costs of the plurality of states by using a cost function model. The first processor 14 calculates costs of a plurality of states at times subsequent to the time from the control sequence fed back to the second recurrent neural network from the second processor 15 and the current state.

In the present embodiment, the first processor 14 includes the Monte Carlo simulator 141 and a storage 142, as illustrated in FIG. 3B.

The Monte Carlo simulator 141 employs a scheme of a path integral that stochastically samples a time series of a plurality of different states by using Monte Carlo simulation. The time series of states is referred to as a trajectory. The Monte Carlo simulator 141 calculates a time series of states having states at times after the current time as its components from the current state and the initial control sequence by using a machine-learned dynamics model 1411 and random numbers input from the third processor 16, as illustrated in, for example, FIG. 4. Then, the Monte Carlo simulator 141 receives the calculated time series of states again and updates this time series of state. In this way, the Monte Carlo simulator 141 calculates the state at each time after the current time by recurrently updating the time series of states, for example, N times. The Monte Carlo simulator 141 calculates the cost of a state calculated at an Nth time, that is, the last time in a terminal cost calculating section 1412 and outputs it as a terminal cost to the storage 142.

More specifically, for example, it is assumed that the dynamics model 1411 is expressed as

f(xₜ_{ᵢ}^{(k)},uₜ_{_{i+δδu}}ₜ_{ᵢ}^{(k)};α),

a cost function model 1413 is expressed as

\tilde{q}(xₜ_{ᵢ}^{(k)},uₜ_{ᵢ}+δuₜ_{ᵢ}^{(k)};β,R),

and the terminal cost model in the terminal cost calculating section 1412 is expressed as

ϕ(xₜ_{_{N}}^{(k)};γ),

where α, β, R, and γ are parameters for the dynamics model and cost function model. In this case, first, the Monte Carlo simulator 141 substitutes the current state

xₜ_{₀}

into the state at time ti

xₜ_{ᵢ}^{(k)}

Here, k is an index indicating one of K states in total. The K states are processed in parallel. Then, from the state

xₜ_{ᵢ}^{(k)}

and the initial control sequence

uₜ_{ᵢ}

by using the dynamics model 1411

f(xₜ_{ᵢ}^{(k)},uₜ_{ᵢ}+δuₜ_{ᵢ}^{(k)};α)

and random numbers

δuₜ_{ᵢ}^{(k)}

the Monte Carlo simulator 141 calculates the state at time ti+1 after time ti

xₜ_{ᵢ₊₁}^{(k)}

Then, the Monte Carlo simulator 141 receives the calculated state

xₜ_{ᵢ₊₁}^{(k)}

again as the state at time ti

xₜ_{ᵢ}^{(k)}

and updates the K states

xₜ_{ᵢ₊₁}^{(k)}

The Monte Carlo simulator 141 inputs the state calculated at the Nth time

xₜ_{ᵢ₊₁}^{(k)}

into the terminal cost calculating section 1412 and outputs the obtained terminal cost

qₜ_{_{N}}^{(k)}

to the storage 142.

The Monte Carlo simulator 141 calculates an evaluation cost being costs of a plurality of states calculated at times from the initial control sequence by using the cost function model 1413 and the random numbers input from the third processor 16.

More specifically, by using the cost function model 1413

\tilde{q}(xₜ_{ᵢ}^{(k)},uₜ_{ᵢ}+δuₜ_{ᵢ}^{(k)};β,R)

and the random numbers input from the third processor 16

{δuₜ_{ᵢ}^{(k)}}

from the initial control sequence

{uₜ_{ᵢ}}

the Monte Carlo simulator 141 outputs costs of a plurality of states at times calculated at 1st to (N−1)th times

qₜ_{ᵢ}^{(k)}

as the evaluation cost to the storage 142.

The portion that recurrently calculates a plurality of states in the Monte Carlo simulator 141 corresponds to a recurrent neural network 141a. One example of the recurrent neural network 141a may be the first recurrent neural network. The N times indicates the number of time steps at which prediction is made.

One example of the storage 142 may be a memory and temporarily stores the evaluation cost)

{qₜ_{ᵢ}^{(k)}}

being costs of a plurality of states at each time for N times and outputs them to the second processor 15.

### <<Second Processor 15>>

The second processor 15 calculates a control sequence for the control target at each time on the basis of an initial control sequence and costs of a plurality of states. The second processor 15 outputs the calculated control sequence at each time to the output section 4 and feeds it back to the second recurrent neural network as the initial control sequence.

In the present embodiment, the second processor 15 includes a cost integrator 151 and a control sequence updating section 152, as illustrated in, for example, FIG. 5.

The cost integrator 151 calculates an integrated cost in which the costs of the plurality of states at each time for N times stored in the storage 142 are integrated. More specifically, the cost integrator 151 calculates an integrated cost

sₜ_{₀}^{(k)}

in which the costs of the plurality of states at each time for N times stored in the storage 142 are integrated by using Expression 1 below

sₜ_{₀}^{(k)}=Σⱼ₌₀^{N-1}qₜ_{ⱼ}^{(k)} (Expression 1)

The control sequence updating section 152 calculates the control sequence in which the initial control sequence is updated for the control target 50 from the initial control sequence, the integrated cost of the costs of the plurality of states at each time for N times integrated in the cost integrator 151, and the random numbers input from the third processor 16. More specifically, from the initial control sequence

{uₜ_{ᵢ}},

the integrated cost calculated in the cost integrator 151

sₜ_{ᵢ}^{(k)},

and the random numbers input from the third processor 16

{δuₜ_{ᵢ}^{(k)}}

the control sequence updating section 152 calculates the control sequence for the control target 50

{uₜ_{ᵢ}*}

by using Expression 2

$${u}_{{t}_{0}} + \frac{{\sum }_{k = 0}^{K - 1} [ exp ( - {S}_{{t}_{0}}^{( k )} / λ ) δ {u}_{{t}_{0}}^{( k )} ]}{{\sum }_{k = 0}^{K - 1} [ exp ( - {S}_{{t}_{0}}^{( k )} / λ ) ]} \qquad ( Expression 2 )$$

### <<Third Processor 16>>

The third processor 16 generates random numbers for use in the Monte Carlo method. The third processor 16 outputs the generated random numbers to the first processor 14 and second processor 15.

In the present embodiment, the third processor 16 includes a noise generator 161 and a storage 162, as illustrated in FIG. 3B.

The noise generator 161 generates, for example, Gaussian noise as random numbers

{δuₜ_{ᵢ}^{(k)}}

and stores them in the storage 162.

One example of the storage 162 may be a memory and temporarily stores the random numbers

{δuₜ_{ᵢ}^{(k)}}

and outputs them to the first processor 14 and second processor 15.

### [Operations of Control Device 1]

Example operations of the control device 1 having the above-described configuration are described below.

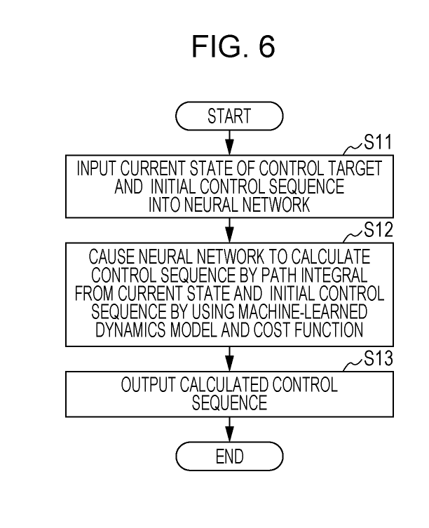

FIG. 6 is a flow chart that illustrates processing in the control device 1 according to the present embodiment. The control device 1 includes a path integral control neural network being the neural network in the present disclosure. The path integral control neural network includes a machine-learned dynamics model and cost function. The path integral control neural network includes the double recurrent neural network. That is, the path integral control neural network includes the second recurrent neural network incorporating the first recurrent neural network including the dynamics model, as previously described.

First, the control device 1 inputs a current state of the control target 50 and an initial control sequence being a control sequence having a plurality of control parameters for the control target as its components into the path integral control neural network being the neural network in the present disclosure (S11).

Next, the control device 1 causes the path integral control neural network to calculate a control sequence for controlling the control target 50 by path integral from the current state and initial control sequence input at S11 by using the machine-learned dynamics model and cost function (S12).

Then, the control device 1 outputs the control sequence for controlling the control target 50 calculated at S12 by the path integral control neural network (S13).

### [Learning Processing]

In the present disclosure, a path integral controller being one of optimal controllers is noted to cause a dynamics and cost function required for optimal control or their parameters to learn by using a neural network. Because functions formularized to achieve the path integral controller are differential, a chain rule being a rule for differentiating a composition of functions can be applied. A deep neural network can be interpreted as a composition of functions that is a large aggregate of differential functions and that can learn by a chain rule. It is found that when a rule of being differential is observed, a deep neural network having any shape can be formed.

From the foregoing, it is conceived that because the path integral controller is formularized as differential functions and a chain rule is applicable, it can be achieved by the use of a deep neural network in which all parameters can learn by backpropagation. More specifically, a recurrent neural network being one of deep neural networks can be interpreted as a neural network in which the same function is performed a plurality of times in series, that is, functions are aligned in series. From this, it is conceived that the path integral controller can be represented as the recurrent neural network.

Accordingly, a dynamics and cost function required for path integral control or their parameters can learn by using a neural network. In addition, as previously described, path integral control, that is, optimal control by path integral can be achieved by using a leaned dynamics and cost function or the like, as previously described.

Learning processing of parameters of a dynamics and cost function required for path integral control is described below.

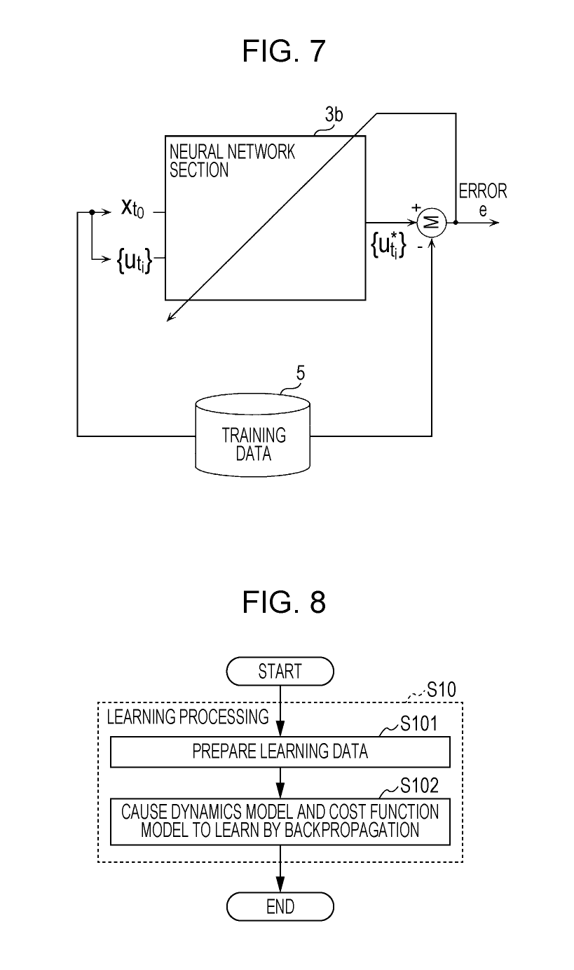

FIG. 7 illustrates one example of a conceptual diagram of learning processing according to the present embodiment. A neural network section 3b includes a dynamics model and cost function model before learning. By learning of the dynamics model and cost function model, they can be applied as the dynamics model and cost function model in the neural network section 3 included in the control device 1.

FIG. 7 illustrates one example case where learning processing of causing the dynamics model and cost function model in the neural network section 3b to learn by backpropagation using training data 5 is performed. If there is no training data, reinforcement learning may be used in the learning processing.

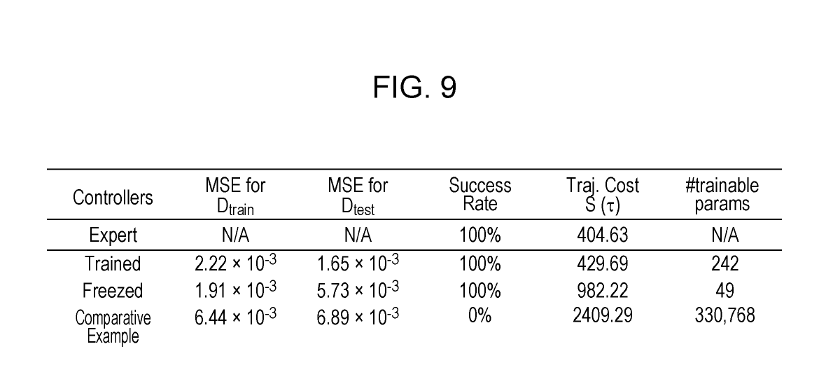

FIG. 8 is a flow chart that illustrates an outline of learning processing S10 according to the present embodiment.

At the learning processing S10, first, learning data is prepared (S101). More specifically, learning data is prepared that includes a prepared state corresponding to a current state of the control target 50, a prepared initial control sequence corresponding to an initial control sequence for the control target 50, and a control sequence for controlling the control target calculated from the prepared state and the prepared initial control sequence by path integral. In the present embodiment, an expert's control history including a set of a state and a control sequence is prepared as the learning data.

Next, a computer causes the dynamics model and cost function model to learn by causing a weight in the neural network section 3b to learn by backpropagation by using the prepared learning data as training data (S102). More specifically, the computer causes the neural network section 3b to calculate a control sequence by path integral by using the learning data from the prepared state and the prepared initial control sequence included in the learning data. Then, the computer evaluates an error between the control sequence calculated by the neural network section 3b by path integral and the prepared control sequence included in the learning data by using a prepared evaluation function or the like and updates parameters of the dynamics model and cost function model such that the error is reduced. The computer adjusts or updates the parameters of the dynamics model and cost function model to a state in which the error evaluated with the prepared evaluation function or the like in the learning processing is minimized or does not vary.

In this way, the computer causes the dynamics model and cost function model in the neural network section 3b to learn by backpropagation of evaluating the error by using the prepared evaluation function or the like and repeating updating the parameters of the dynamics model such that it is reduced.

In the present embodiment, by the learning processing S10, the dynamics model and cost function model in the neural network section 3 used in the control device 1 can learn.

When the training data includes a data set of state, control, and next state, the dynamics model can be independently subjected to supervised learning by using this data. When the independently learned dynamics model is embedded in the neural network section 3 and the parameters in the dynamics model are fixed, the cost function model can learn alone by using the learning processing S10. Because a method of supervised learning for the dynamics model is known, it is not described here.

In the following description, the neural network section 3 is referred to as a path integral control neural network being the neural network in the present disclosure.

### [Experimental Verification]

The effectiveness of the path integral control neural network including a learned dynamics and cost function model was verified by experiment. The experimental results are described below.

One issue of optimal control is simple pendulum swing-up control of swinging a simple pendulum facing downward up to an upside down position. In the present experiment, a dynamics and cost function used in the pendulum swing-up control was subjected to imitation learning by using training data from an expert, the pendulum swing-up control was simulated, and its effectiveness was verified.

### <Training Data>

In the present experiment, the expert is an optimal controller having a real dynamics and cost function. The real dynamics is given by Expression 3 below, and the cost function is provided by Expression 4 below.

\ddot{θ}=−sin θ+k·u (Expression 3)

(1+cos θ)²+\dot{θ}²+5·u² (Expression 4)

Here, θ denotes an angle of the pendulum, k denotes a model parameter, and u denotes a torque, that is, control input.

### <Experimental Results>

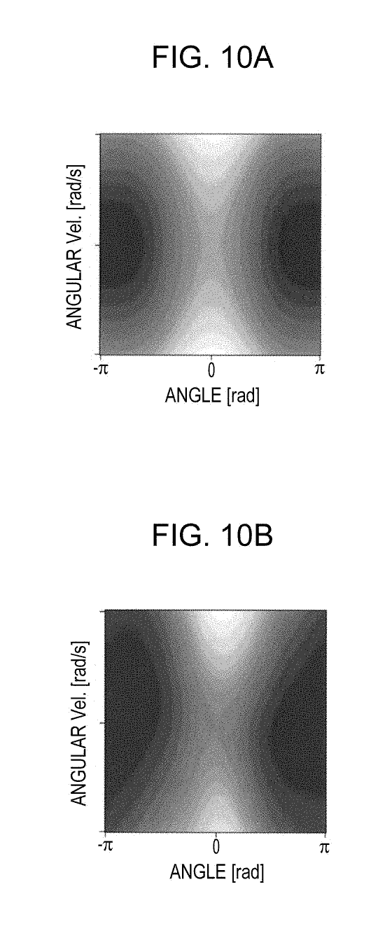

FIG. 9 illustrates results of control simulation in the present experiment.

In the present experiment, a dynamics and cost function were represented by a neural network having a single hidden layer. By the above-described method, the dynamics independently learned with training data, and then the cost function learned so as to output desired output by backpropagation. The path integral control neural network subjected to such learning processing is represented as “Trained” in Controllers in FIG. 9. The dynamics independently learned with the above-described training data, learning for the cost function is not performed and the real cost function indicated by Expression 4 was provided to the path integral control neural network, and the obtained result is represented as “Freezed” in Controllers in FIG. 9. A value iteration network (VIN) described in Aviv Tamar, Yi Wu, Garrett Thomas, Sergey Levine, and Pieter Abbeel, “Value Iteration Networks,” NIPS 2016 (hereinafter referred to as Non Patent Literature 2) is represented as Comparative Example in Controllers in FIG. 9. The dxVIN is a neural network in which a state transition model and reward model learns by backpropagation, as illustrated in Non Patent Literature 2. In the present experiment, the VIN learned with the above-described training data by using the state transition model as the dynamics and the reward model as the cost function.

The item MSE For Dₜᵣₐᵢₙ in FIG. 9 indicates an error for training data, and the item MSE For Dₜₑₛₜ in FIG. 9 indicates an error for evaluation data, that is, a generalization error. The item Success Rate in FIG. 9 indicates a success rate of swing-up, and the 100% success rate indicates cases where the swing-up succeeds when actual control is performed. The item traj.Cost S(τ) in FIG. 9 indicates an accumulated cost and indicates a cost of a trajectory from the simple pendulum facing downward to a swung-up state being an inverted state. The item trainable params in FIG. 9 indicates the number of parameters.

FIG. 9 reveals that “Trained” has the highest generalization performance. The reason why the generalization performance for “Freezed” is lower than that for “Trained” may be that the dynamics that has learned in first learning processing is not optimized by second learning processing. That is, it can be considered that because of the effect of an error of the dynamics that has learned in the first learning processing, the generalization performance for “Freezed” is low.

In the comparative example, the success rate of swing-up control is 0%, which means that the swing-up did not succeed. This may be because the number of parameters to learn is so large that a state explosion occurs in the comparative example. This reveals that it is difficult to cause the dynamics model and cost function to learn in the neural network in the comparative example.

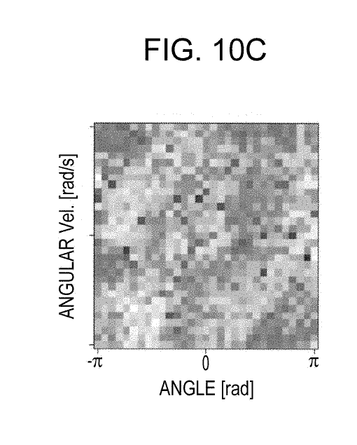

Next, results of learning in the present experiment are described with reference to FIGS. 10A to 10C.

FIG. 10A illustrates a real cost function in which the cost function indicated by Expression 4 above is visualized. FIG. 10B illustrates a cost function in a learned path integral control neural network in which the cost function learned in “Trained” in the present experiment is visualized. FIG. 10C illustrates a cost function in a learned neural network in the comparative example in which the cost function learned in the comparative example is visualized.

Comparison between FIGS. 10A and 10B reveals that the cost function in “Trained,” that is, the cost function in the path integral neural network learns with a shape similar to the real cost function in shape.

FIG. 10C reveals that the cost function in the comparative example has no shape. This indicates that the cost function in the neural network in the comparative example cannot learn.

The above experimental results reveal that the path integral control neural network being the neural network in the present disclosure can cause the cost function to learn with a shape similar to the real cost function. It is revealed that the path integral control neural network utilizing the learned cost function has high generalization performance.

From the foregoing, it is found that the path integral control neural network being the neural network in the present disclosure is capable of not only causing the dynamics and cost function required for optimal control to learn but also obtaining the generalization performance and making prediction.

### [Advantages and the Like]

The use of the path integral control neural network being the neural network in the present disclosure and including the double recurrent neural network enables learning of the dynamics and cost function required for optimal control by path integral or their parameters, as described above. Because the path integral control neural network can obtain high generalization performance by imitation learning, a control device or the like also capable of making prediction can be achieved. That is, according to the control device and control method in the present embodiment, the neural network including the double recurrent neural network can perform optimal control by path integral, and thus the optimal control by path integral by using the neural network can be achieved.

In addition, as described above, a learning method known in learning in the neural network, such as backpropagation, can be used in learning of the dynamics and cost function in the path integral control neural network. That is, according to the control device and control method in the present embodiment, parameters that are difficult to describe, such as those in a dynamics and cost function required for optimal control, can easily learn by using the known learning method.

According to the control device and control method in the present embodiment, because a path integral control neural network that can be represented by a composition of differential functions is used, continuous control of processing a state and control of the control target by using continuous values can be achieved. According to the control device and control method in the present embodiment, because the path integral control neural network that can be represented by the composition of differential functions is used, the cost function can be represented flexibly. That is, the cost function can be represented as a neural network model, and can also learn by using a neural network even with a mathematical expression.

### (First Variation)

In the above-described embodiment, the neural network section 3 is described as including only the calculating section 13 and as outputting a control sequence calculated by the calculating section 13. The present disclosure is not limited to this example. The neural network section 3 may output a control sequence averaged by the calculating section 13. This case is described as a first variation below, and points different from the embodiment are mainly described.

### [Neural Network Section 30]

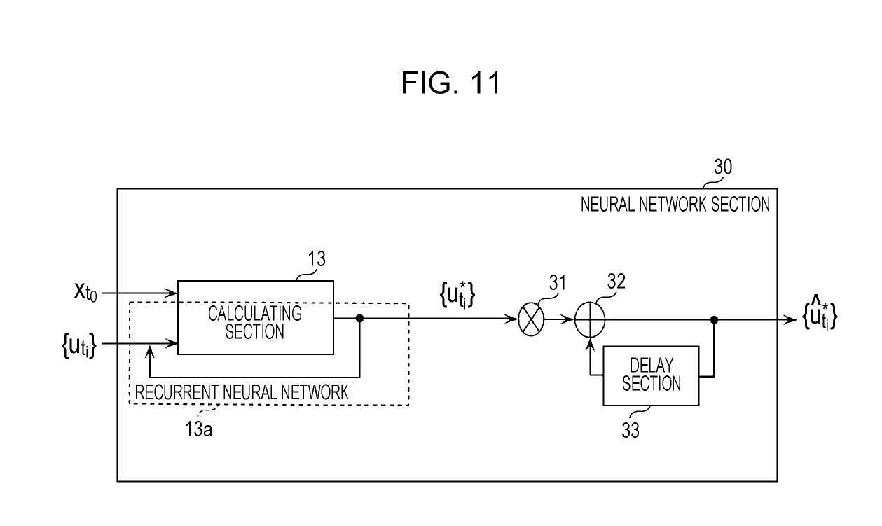

FIG. 11 is a block diagram that illustrates one example of a configuration of a neural network section 30 according to the first variation. The same reference numerals are used in the same elements as in FIG. 2, and a detailed description thereof is omitted.

The neural network section 30 in FIG. 11 differs from the neural network section 3 in FIG. 2 in that it further includes a multiplier 31, an adder 32, and a delay section 33.

### <Multiplier 31>

The multiplier 31 multiplies a control sequence calculated by the calculating section 13 by a weight and outputs it to the adder 32. More specifically, the multiplier 31 multiplies a control sequence by a weight w; every time the calculating section 13 updates the control sequence and outputs it to the adder 32. The calculating section 13 calculates a control sequence

{uₜ_{ᵢ}*}

for controlling the control target by recurrently updating the control sequence U times, as described above. Because the control sequence updated by the calculating section 13 later has smaller variations, the weight wᵢ is determined so as to satisfy Expression 5 below and so as to increase with an increase in the number of updates by the calculating section 13.

Σᵢ^{U-1}wᵢ=1 (Expression 5)

### <Adder 32>

The adder 32 adds a control sequence multiplied by the weight output from the multiplier 31 and an earlier control sequence multiplied by the weight output from the multiplier 31 together and outputs the sum. More specifically, the adder 32 outputs a mean control sequence

{ûₜ_{ᵢ}*}

as output from the neural network section 30, the means control sequence being obtained by weighting and averaging all the control sequence by adding all the control sequences multiplied by the weight output from the multiplier 31 together.

### <Delay Section 33>

The delay section 33 delays a result of addition by the adder 32 by a fixed time interval and provides it to the adder 32 with an updating timing. In this way, the delay section 33 can cause the adder 32 to weight and average all the control sequences output from the calculating section 13 to the adder 32 by integrating all of the control sequences multiplied by the weight output from the multiplier 31.

Other configurations and operations in the control device in the present variation are substantially the same as those in the control device 1 in the above-described embodiment.

### [Advantages and the Like]

According to the control device in the present variation, the control sequence updated by the calculating section 13 is not output as it is, and the control sequences multiplied by the weight, which is larger as it is updated later, are integrated and output. Therefore, as the number of updates is larger, variations in the control sequence are smaller, and this can be utilized. In other words, even when the gradient diminishes because the recurrent neural network is subjected to learning by backpropagation, this issue can be solved by weighting the control sequences such that the weight is larger as the control sequence is updated later and averaging them.

### Possibilities in Other Embodiments

The control device and control method in the present disclosure are described above in the present embodiment. The present disclosure is not limited to the above-described embodiment. For example, another embodiment achieved by combining elements described in the present specification or excluding some of the elements may be an embodiment in the present disclosure. Variations obtained by applying various modifications to the above-described embodiment within the range where a person skilled in the art can conceive without departing from the scope of the present disclosure, that is, the wording described in claims are also included in the present disclosure.

The present disclosure further includes the cases described below.

(1) An example of the above-described device may be a computer system including a microprocessor, read-only memory (ROM), random-access memory (RAM), hard disk unit, display unit, keyboard, mouse, and the like. The RAM or hard disk unit stores a computer program. Each of the devices performs its functions by the microprocessor operating accordance to the computer program. Here, the computer program is a combination of instruction codes indicating instructions to the computer.

(2) Some or all of the constituent elements in the above-described device may be configured as a single system large scale integration (LSI). The system LSI is a super multi-function LSI produced by integrating a plurality of element sections on a single chip, and one example thereof may be a computer system including a microprocessor, ROM, RAM, and the like. The RAM stores a computer program. The system LSI performs its functions by the microprocessor operating according to the computer program.

(3) Some or all of the constituent elements in the above-described device may be configured as an integrated circuit (IC) card or a single module attachable or detachable to or from each device. The IC card or the module is a computer system including a microprocessor, ROM, RAM, and the like. The IC card or the module may include the above-described super multi-function LSI. The IC card or the module performs its functions by the microprocessor operating according to a computer program. The IC card or the module may be tamper-resistant.

(4) The present disclosure may include the above-described method. The present disclosure may be a computer program that achieves the method by a computer or may be digital signals corresponding to the computer program.

(5) The present disclosure may also include a computer-readable recording medium, such as a flexible disk, hard disk, CD-ROM, magneto-optical (MO) disk, digital versatile disk (DVD), DVD-ROM, DVD-RAM, Blu-ray (registered trademark) disc (BD), and semiconductor memory, that stores the computer program or the digital signals. The present disclosure may also include the digital signals stored on these recording media.

The present disclosure may also include transmission of the computer program or the digital signals over a telecommunication line, wireless or wired communication line, network, typified by the Internet, data casting, and the like.

The present disclosure may also include a computer system including a microprocessor and memory, the memory may store the computer program, and the microprocessor may operate according to the computer program.

The program or the digital signals may be executed by another independent computer system by transferring the program or the digital signals stored on the recording medium or by transferring the program or the digital signals over the network or the like.

The present disclosure is applicable to a control device and control method performing optimal control. The present disclosure is applicable to a control device and control method that causes parameters, in particular, those difficult to describe in a dynamics and cost function to learn by using a deep neural network and that causes the deep neural network to perform optimal control by using the learned dynamics and cost function.

What is claimed is:

1. A control device for performing optimal control by path integral, the control device comprising:
a processor; and
a non-transitory memory storing thereon a computer program, which when executed by the processor, causes the processor to perform operations including:
inputting a current state of a control target and an initial control sequence being a control sequence having a plurality of control parameters for the control target as its components into a neural network including a machine-learned dynamics model and cost function; and
outputting a control sequence for controlling the control target, the control sequence being calculated by the neural network by path integral from the current state and the initial control sequence by using the dynamics model and the cost function,
wherein the neural network includes a first recurrent neural network and a second recurrent neural network,
wherein the first recurrent neural network has the dynamics model,
wherein the second recurrent neural network incorporates the first recurrent neural network.

2. The control device according to claim 1, wherein the second recurrent neural network includes
a first processing unit that includes the first recurrent neural network and the cost function and configured to cause the first recurrent neural network to calculate states at times by a Monte Carlo method from the current state and the initial control sequence and to calculate costs of the plurality of states by using the cost function, and
a second processing unit configured to calculate the control sequence for the control target on the basis of the initial control sequence and the costs of the plurality of states,
the second processing unit configured to output the calculated control sequence and feed the calculated control sequence as the initial control sequence back to the second recurrent neural network, and
the second recurrent neural network configured to cause the first processing unit to calculate costs of a plurality of states at times subsequent to the times from the control sequence fed back from the second processor and the current state.

3. The control device according to claim 2, wherein the second recurrent neural network further includes
a third processing unit configured to generate random numbers by the Monte Carlo method, and
the third processing unit configured to output the generated random numbers to the first processing unit and the second processing unit.

4. The control device according to claim 1, wherein the control target is a autonomously moving vehicle or a autonomously moving robot,
the cost function is a cost function model included in the neural network, and
in the outputting, the control sequence is output to the autonomously moving vehicle or the autonomously moving robot, and the autonomously moving vehicle or the autonomously moving robot is controlled.

5. A control method for use in a control device for performing optimal control by path integral, the control method comprising:
inputting a current state of a control target and an initial control sequence being a control sequence having a plurality of control parameters for the control target as its components into a neural network including a machine-learned dynamics model and cost function; and
outputting a control sequence for controlling the control target, the control sequence being calculated by the neural network by path integral from the current state and the initial control sequence by using the dynamics model and the cost function,
wherein the neural network includes a first recurrent neural network and a second recurrent neural network,
wherein the first recurrent neural network has the dynamics model,
wherein the second recurrent neural network incorporates the first recurrent neural network.

6. The control method according to claim 5, further comprising:
learning before the inputting, in the learning, the dynamics model and the cost function are subjected to machine learning,
wherein the leaning includes
preparing learning data as training data, the learning data including a prepared state corresponding to the current state of the control target, a prepared initial control sequence corresponding to the initial control sequence for the control target, and a control sequence for controlling the control target calculated by path integral from the prepared state and the prepared initial control sequence, and
causing the dynamics model and the cost function to learn by causing a weight in the neural network to learn by backpropagation by using the training data.

7. The control device according to claim 5, wherein the control target is a autonomously moving vehicle or a autonomously moving robot,
the cost function is a cost function model included in the neural network, and
in the outputting, the control sequence is output to the autonomously moving vehicle or the autonomously moving robot, and the autonomously moving vehicle or the autonomously moving robot is controlled.
